(19) United States
(12) Patent Application Publication
(10) Pub. No.: US 2008/0031217 A1
(43) Pub. Date: Feb. 7, 2008

(54) Method For Selecting Receiving Stations In A Data Radio Transmitting System

(75) Inventors: Thomas Bonald, Voisins Lez Bretonneux (FR); Alexandre Proutier, Paris (FR)

Correspondence Address: Thomas Langer;COHEN PONTANI LIEBERMAN & PAVANE, Suite 1210, 551 Fifth Avenue, New York, NY, 10176, US

(73) Assignee: FRANCE TELECOM, Paris (FR)

(21) Appl. No.: 11/632,692

(22) PCT Filed: Jun. 20, 2005
(86) PCT No.: PCT/FR05/01540

§ 371 Date: Jan. 16, 2007

(30) Foreign Application Priority Data
Jul. 13, 2004 (FR) 0451529

(51) Int. Cl. H04B 7/212

(52) U.S. Cl. 370/347

(57) ABSTRACT

A method of selecting destination receiver stations in a system for radio transmission of data from a sender station to a plurality of receiver stations, said radio transmitting system using a time division multiple access (TDMA) mechanism with joint coding. The method comprises the steps of establishing a list of a plurality N of receiving stations which are classified according to a radio reception quality indicator (CQI) of each receiving station, dividing said list into P groups of receiving stations, and selecting a destination receiving station in each of said groups for each time slot of said multiple access mechanism.

The present invention relates to a method of selecting destination receiver stations in a system for transmitting data by radio from a sender station to a plurality of receiver stations.

The invention finds a particularly advantageous application in the field of mobile radio networks and more particularly in that of the transmission of data between a base station and mobile stations.

Generally speaking, in a mobile telephone network, the base stations of the network are called upon to supply data to mobile stations of subscribers of said network. The mobile stations suitable for receiving data from the same base station constitute a cell. Most of the time, the data sent by the base station consists of digital files that are transmitted to the receiver mobile stations sporadically, that is to say when necessary, using a carrier frequency in a given radio channel.

More precisely, third generation radio systems such as the HSDPA (High Speed Data Packet Access) UMTS use a time division multiple access (TDMA) mechanism for the downlink radio transmission of data. In substance, this time-sharing technique amounts to defining time windows (“slots”) with a duration of the order one millisecond, for example, and transmitting the data to a destination receiver mobile station when one of those time slots is open.

Another known access mechanism, designated by the abbreviation CDMA (“Code Division Multiple Access”), consists in assigning to each receiver mobile station a specific code and, for transmitting data addressed to a destination receiver station, coding that data by means of the code that has been allocated to that station. All the mobile stations then receive the coded data and use their own codes to decode it. Of course, only the mobile station having the code used for the original coding will be able to reconstitute properly the data sent by the sender base station.

Compared to the CDMA mechanism, the advantages of the TDMA mechanism are as follows:

improved adaptation to the sporadic nature of the data traffic because of the absence of signaling prior to transmission (“connectionless” mode);

absence of intra-cellular interference, i.e. interference between signals addressed to receiver mobile stations attached to the same cell;

increased transmission bit rate capacity by using “opportunistic” scheduling algorithms that preferably select a mobile receiver station with favorable radio reception conditions.

The opportunistic algorithms exploit the independence of the rapid variations in the radio conditions of each mobile station. They necessitate a backward channel from each mobile station to the base station to provide periodic information representative of the quality of reception of the radio channel. In practice, the base station sends the same reference signal to all mobile stations, which in turn send back the received signal level, timed by the opening of the time slots.

However, the drawback of the TDMA mechanism is that it cannot achieve the bit rate capacity promised by information theory, as explained in the paper by L. Li and A. J. Goldsmith “Capacity and optimal resource allocation for fading broadcast channels”, Part 1: Ergodic capacity, IEEE Transactions on Information Theory, Vol. 47, No. 3, March 2001.

To increase the bit rate capacity of a mobile station cell, it is advantageous to be able to transmit to a plurality of mobile stations in a given time slot, rather than to only one mobile station. To this end, one solution is to add to the TDMA mechanism in the strict sense a coding of the mobile stations that then allows simultaneous sending in the same time slot to a set of receiver mobile stations distinguished by their codes using a mechanism analogous to the CDMA mechanism. However, the coding used in combination with the TDMA mechanism relies on a specific “joint coding” technique which has the special feature of limiting the interference between mobile stations of the same cell. One example of this type of joint coding is described in the paper by A. N. Barreto and G. Fettweis “Joint signal preceding in the downlink of spread-spectrum systems”, IEEE Transactions on Wireless Communications, Vol. 2, No. 3, May 2003.

It will nevertheless be observed that the number of mobile stations multiplexed in the same time slot using the TDMA mechanism with joint coding is relatively limited because:

the bit rate improvement resulting from such multiplexing increases with the difference between the reception conditions of the mobile stations;

the complexity of joint coding increases strongly with the number of mobile stations in a multiplex;

the efficacy of the opportunistic scheduling algorithm decreases rapidly with the number of mobile stations in a multiplex.

The HSDPA UMTS standard provides the possibility of allocating radio resources in accordance with that multiplexing scheme, which may be seen as a TDMA mechanism with a few multiplexed mobile stations in each time slot (typically 1, 2 or 3). However, that standard, based on CDMA technology, makes no provision for the use of joint coding.

Moreover, the prior art, including the above-mentioned paper by Li and Goldsmith, at present gives no practical indication as to how to select the mobile stations to be multiplexed if joint coding is used.

Thus the technical problem to be solved by the present invention is to propose a method of selecting destination receiver stations in a radio system for transmitting data from a sender station to a plurality of receiver stations, said radio transmission system using a time division multiple access mechanism with joint coding, which would enable appropriate selection of the mobile stations to which the base station must send simultaneously in order best to approximate the maximum capacity of a cell as predicted by information theory at the same time as preserving the advantages of the TDMA mechanism referred to above.

According to the present invention, the solution to the stated technical problem consists in that said method comprises the steps of:

establishing a list of receiver stations classified as a function of a radio reception quality indicator for each receiver station;

dividing said list into P groups of receiver stations;

selecting a destination receiver station in each of said groups for each time slot of said multiple access mechanism.

Thus, using the method according to the invention, the receiver mobile stations selected can have different radio reception qualities, in accordance with the prescriptions of information theory relating to data bit rate optimization.

According to the invention, the step of selecting a destination receiver station in each of said groups is effected by means of an opportunistic scheduling algorithm.

In this sense, according to the invention, the receiver stations selected are, for example, those which, in their group, have the highest instantaneous reception quality indicator.

In another embodiment of the invention, the receiver stations selected are those that have the highest ratio in their group between the instantaneous reception quality indicator and the average reception quality indicator.

The invention also provides for the receiver stations selected to be those that have the highest ratio in their group between the instantaneous reception quality indicator and a value representing the average data bit rate received over a time slot.

The following description with reference to the appended drawings, which are provided by way of non-limiting example, explains clearly in what the invention consists and how it may be implemented.

FIG. 1 is a diagram of a communications system linking a sender base station and receiver mobile stations and using the selection method according to the invention.

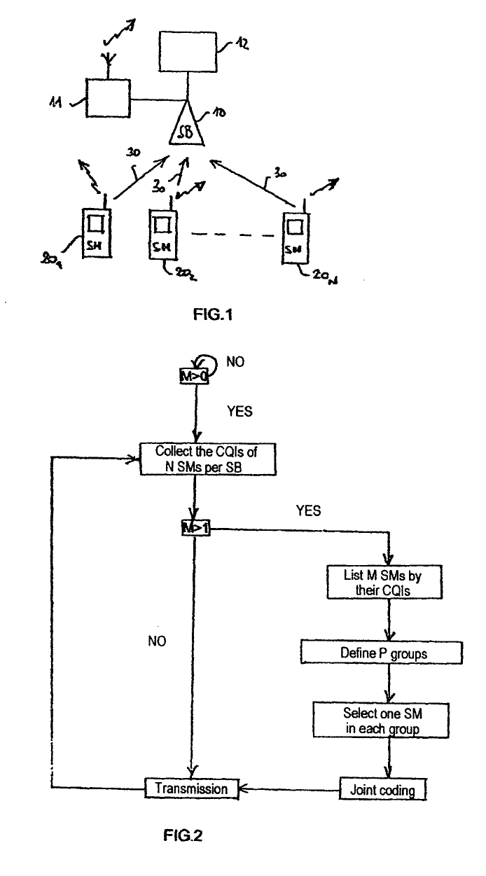

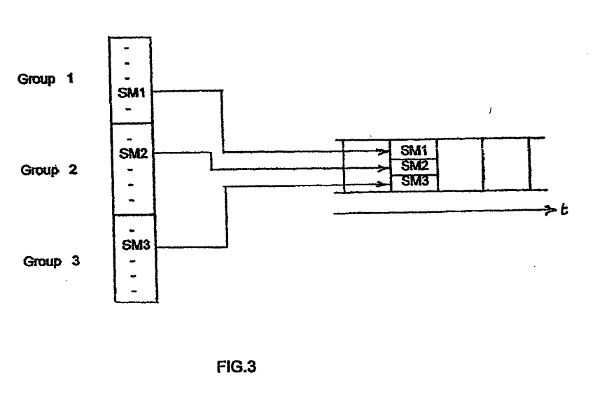

FIG. 2 is a flowchart representing the steps of the selection method according to the invention.

FIG. 3 is a diagram of the content of a series of time slots of a multiple access mechanism using the selection method according to the invention.

FIG. 1 represents a communications system linking a base station (SB) 10 and a plurality of mobile stations (SM) 20₁, 20₂, . . . , 20_{N} constituting a cell in a mobile telephone network, for example. The number N of mobile stations can obviously vary.

The N mobile stations SM are adapted to receive from the base station (SB) 10 via a radio interface 11 data transmitted on a radio-frequency channel allocated to the network.

The data to be transmitted consists of digital files of finite length, and so at a given time only a few mobile stations are receiving data, and these receiver mobile stations are referred to as active or destination mobile stations.

To each destination mobile station there therefore corresponds a set of data to be transmitted from the sender base station 10 that is held in a memory space of the base station itself or in an element 12 of the network to which the base station 10 is connected.

The transmission of data as such is effected by means of the Time Division Multiple Access (TDMA) mechanism with joint coding, as explained above. Remember that this mechanism retains the advantages of the strict TDMA mechanism at the same time as increasing the bit rate capacity by sending to a plurality of destination receiver stations SM multiplexed by joint coding simultaneously (i.e. in the same time slot).

Because of the use of opportunistic scheduling algorithms, the reception quality of each receiver station SM must be known. It is expressed by a channel quality indicator (CQI) that is measured for each time slot as the level at which a reference radio signal sent by the base station is received.

The values of this indicator for each mobile station SM measured over a certain number of time slots are sent to the base station 10 (arrow 30) and may be stored in a memory, for example to establish averages. This phase of collecting the reception quality indicators CQI is shown in FIG. 2 as an initial step of the method according to the invention described in detail next.

When the base station 10 has to transmit data to certain destination receiver stations of the N mobile stations of the cell concerned, the number M of destination stations (M≦N) is tested.

If M=1, then only one mobile station is to be sent data, and the base station 10 then sends the data directly to that destination station.

If M>1, then the method of selecting destination stations for which data will be transmitted simultaneously in the same time slot by the TDMA mechanism with joint coding is as follows.

In a first step, a list is established of the M destination stations classified in decreasing order of their radio reception quality indicator CQI, for example.

In a second step, the list previously established is divided into P groups, the first group containing the receiver mobile stations having the highest indicators CQI and the last group consisting of the receiver mobile stations with the lowest indicators.

Finally, in a third step, the destination mobile stations for which data will be transmitted in the same time slot are selected from the M destination mobile stations so that they belong to different groups, as shown in the FIG. 3 diagram. This optimizes the bit rate capacity as predicted by information theory, which teaches that the maximum capacity is obtained for receiver stations having different radio reception qualities.

The data relating to the destination receiver stations that has been held back pending transmission in the same time slot is then encoded according to a given joint coding scheme and sent to the cell on the radio channel assigned to the mobile radio network. Each destination mobile station receives all the coded data sent by the base station 10 but, by virtue of the inherent nature of the data coding principle, decodes only data that is addressed to it.

The number P of groups may be set once and for all, each of the groups having a size substantially equal to approximately N/P mobile stations. In practice, to take into account the rapid increase in the complexity of joint coding with the number of mobile stations multiplexed in the same time slot, this number P will not be very high, for example 2 or 3.

However, the number P of groups may have any value and may be fixed dynamically, for example by a minimum group size. With a minimum group size P₀, the total number P of groups is equal to INT(N/P₀). Thus with P₀=5, there will be only one group (P=1) if N<10, so the transmission mode will be the strict TDMA mode since data relating to only one receiver mobile station will be transmitted. For 10≦N<15, P=2 and the data relating to two destination mobile stations will be encoded and sent simultaneously. For 15≦N<20, P=3 and the data relating to three destination mobile stations will be encoded and sent simultaneously, and so on.

The destination mobile station in the group to which the data will be transmitted is selected by means of an opportunistic scheduling algorithm applying a particular metric.

That metric can be defined in many ways, for example:

the highest instantaneous quality indicator;

the highest ratio between the instantaneous receive quality indicator and the average receive quality indicator;

the highest ratio between the instantaneous receive quality indicator and a value representing the average data bit rate received over a time slot.

1. A method of selecting destination receiver stations in a radio system for transmitting data from a sender station to a plurality of receiver stations, said radio transmission system using a time division multiple access mechanism with joint coding, wherein said method comprises the steps of:
establishing a list of receiver stations classified as a function of a radio reception quality indicator for each receiver station;
dividing said list into P groups of receiver stations; and
selecting a destination receiver station in each of said groups for each time slot of said multiple access mechanism.

2. The method according to claim 1, wherein the step of selecting a destination receiver station in each of said groups is effected by means of an opportunistic scheduling algorithm.

3.-6. (canceled)

7. The method according to claim 1, wherein the groups are of substantially identical size.

8. The method according to claim 1, wherein the receiver stations selected are those that have the highest instantaneous reception quality indicator in their group.

9. The method according to claim 1, wherein the receiver stations selected are those that have the highest ratio in their group between the instantaneous reception quality indicator and the average reception quality indicator.

10. The method according to claim 1, wherein the receiver stations selected are those that have the highest ratio in their group between the instantaneous reception quality indicator and a value representing the average data bit rate received over a time slot.

11. A software product carried by a data medium comprising instructions for execution of the method according to claim 1 by an electronic data processing system.

12. A device for selecting destination receiver stations in a radio system for transmitting data from a sender station to a plurality of receiver stations, said radio transmission system using a time division multiple access mechanism with joint coding, the device comprising:
means for establishing a list of the receiver stations classified as a function of a radio reception quality indicator for each receiver station;
means for dividing said list into P groups of receiver stations; and
means for selecting a destination receiver station in each of said groups for each time slot of said multiple access mechanism.

13. The device according to claim 12, wherein said means for selecting a destination receiver station in each of said groups comprise an opportunistic scheduling algorithm.

14. The device according to claim 13, wherein said means for selecting a destination receiver station are adapted to choose the receiver stations that have the highest instantaneous reception quality indicator in their group.

15. The device according to claim 13, wherein said means for selecting a destination receiver station are adapted to choose the receiver stations that have the highest ratio in their group between instantaneous reception quality indicator and the average reception quality indicator.

16. The device according to claim 13, wherein said means for selecting a destination receiver station are adapted to choose the receiver stations that have the highest ratio in their group between the instantaneous reception quality indicator and a value representing the average data bit rate received over a time slot.

17. A sender station, adapted to transmit data by means of a time division multiple access mechanism with joint coding to a plurality of destination receiver stations in a radio data transmission system, the sender station comprising a device according to claim 12 for selecting destination receiver stations.
